(19) United States
(12) Patent Application Publication
(10) Pub. No.: US 2022/0099247 A1
(43) Pub. Date: Mar. 31, 2022

(54) PORTABLE SECURING MECHANISM FOR AN UPRIGHT STAND

(71) Applicants: Clay BUILDER, Dartington Totnes (GB); Nina ANDERSON, Dartington Totnes (GB); Nautibuoy Marine Limited, Devon (GB)

(72) Inventors: Clay L. BUILDER, Devon (GB); Nina ANDERSON, Devon (GB)

(21) Appl. No.: 17/426,693

(22) PCT Filed: Feb. 4, 2020
(86) PCT No.: PCT/EP2020/052766

§ 371 Date: Jul. 29, 2021

(30) Foreign Application Priority Data
Feb. 8, 2019 (GB) 1901788.8

(51) Int. Cl. F16M 13/02; A45B 11/00

(52) U.S. Cl. CPC F16M 13/02; A45B 11/00

(57) ABSTRACT

A securing mechanism suitable for attachment to an inflatable structure for securing a upright supporting stand , comprising: a first securing section, having a first support region for positioning adjacent to the top surface of the structure, a second support region for positioning adjacent to the bottom surface of the structure, a central support joining said first and second regions, a second securing section, connected to said first securing section and extending in an opposite direction, having a first support region, a central region and a second support region, wherein said second securing section is for positioning adjacent to a second inflatable structure; a central fixing area having top and bottom sides, connected on the bottom side proximate to a first region of at least one of said first and second securing sections, wherein part of said central fixing area can be affixed to a stand for supporting an upright.

### FIELD OF INVENTION

This invention relates to a securing mechanism that can be used to attach to inflatable or floatable platform, and that can support a stand for attaching upright structures such as umbrellas, shade poles, lights, fishing rods, tables, flags, barrier poles, tender whips or any other upright structure to inflatable platforms, walkways, pontoons or other objects

### BACKGROUND OF INVENTION

In the field of this invention it is known that floatable inflatable platforms are becoming more and more popular, especially for use in hot climates where UV is a problem. Users may be spending several hours a day, relaxing at water level where they can swim and enjoy being close to the water.

A method of providing shade is needed to prevent skin burning and the obvious negative effects of too much exposure to the suns UV. There are currently two alternative methods of providing shade to a floatable inflatable platform. Inflatable canopies such as shown in FIG. 1 can be unsightly in design due to the size they need to be for people to be able to walk under, also due to the fact they are light in their construction, they can act as a balloon and create lift and windage which is undesirable if attached to a platform on the sea, particularly from a safety point of view if the wind picks up suddenly. They need multiple connection points to strap them down. They take time to inflate and in the event of wind increasing rapidly, take time to deflate and pack away. Also, the shade is in a fixed position and can't be adjusted as the platform moves around on the sea.

A Bimini style arrangement as shown in FIG. 2, is a way of providing shade over inflatable platforms. A bimini requires a large stainless frame that is heavy and difficult to store on board yachts, where stowage is at a premium. The problem with this is arrangement is that the shade is in a fixed position, which may not be the optimum position for covering users, particularly if the inflatable is positioned on a floating platform in the sea facing the sun. Due to changes in sea conditions and currents etc, it is not always possible to keep the inflatable in the desired position to maintain the shade.

It is very difficult to attach a fixed pole umbrella to an inflatable, in such a manner as to keep the umbrella fixed firmly in an upright position, without damaging the inflatable below. For umbrella stands on land very often the bottom part is a container filled with sand or other heavy object such as concrete to providing the necessary stability for the umbrella. Therefore, attaching an upright stand to a light object such as an inflatable, whilst maintaining the stand substantially vertically is challenging.

FIG. 3, FIG. 4, FIG. 5 and FIG. 6 are various different views of a prior art portable upright stand 100 as described in GB1811877.8 In this stand, the umbrella stand is integral with the securing mechanism, which means it is a bulky object, and may be difficult to store. In addition, the stand can only be used with an umbrella which fits in the stand, and it would be desirable to have a mechanism that could be used with a variety of different umbrella stands, for stands with different diameters for example. As shown the stand is made of metal such as stainless steel. The shade has a central hollow tubular section 101, with interior 112 for receiving a stand or other support. The tubular section 101 is affixed at the bottom end to a top surface 103 of a central support plate 102. Close to the top end of the tubular section 101 are one or more D-rings, 107, welded to the outer of tubular section 101, these may be welded anywhere on the outer, but preferably they are equally spaced on the outer surface. When they are separated by 180 degrees, they are positioned so that the D-rings are in line with the edge of the platform when inflated, so that guide wires can be affixed between the portable upright stand and a platform supporting the portable upright stand, in line with fittings on the platform. Guide wires 109, and wire guide 108 are affixed to D-rings 107 to act as secondary support to keep the portable upright stand 100 upright in winds and other atmospheric or water conditions to the top surface of an inflatable platform The tubular section 101 is also provided with locking region 111, that receives a threaded screw 110. When a pole or other upright is inserted into the interior 112 of tubular section 101, the screw 110 is tightened to hold the upright in position in the portable upright stand. There may also be other means of securing a pole/uptight in the interior 112, for example, the tubular section 101 may be provided with a cut-out (not shown) for receiving a push fit connector of the upright, which pops out when the upright is inserted, and will need to be physically depressed to allow the upright to be removed from the interior 112.

Preferably, the tubular section 101 has an inner diameter of 30 mm and length of 195 mm, although other diameters/lengths than are smaller or larger may be possible. Tubular section 101 is fixed to the top surface 103 of central support plate 102, preferably by welding for metal, or by other securing methods if the tube is made of plastic or other non-metallic material, in the centre of the circular metal piece, to house the umbrella pole or upright pole. Preferably, the inner of the tubular section 101 has a circular cross-section, but other cross sections, such as square, rectangular, oval, or other regular shape may be possible.

Attached to the bottom surface 104 of central support plate are elliptical sections 105, 106 that are curved to have a C-shape. Typically, elliptical sections 105, 106 are sized to match the height of the inflatable platform and an inflatable retainer, referred to as an Air Toggle (see GB2531066) they will be affixed to. In a preferred embodiment the height of the platform is 200 mm, so the diameter of sections 105, 106 will be 200 mm, but they may be smaller or larger, for example 100 mm, 150 mm, 300 mm, 350 mm or 450 mm. As shown sections 105, 106 are fixed together, preferably by welding or other securing methods at the centre position 120 (the tangent where the sections touch) to give a shape of two back to back C's in the side view. As shown, the central support plate 102 is circular, and the diameter of the plate is equal to the distance between the top of elliptical sections 105, 106, and the top of the elliptical sections 105, 106 are connected to the outer edge of the bottom surface 104 of support plate 102 at 115. Of course, the support plate may have another shape, and circular is merely the preferred shape for the first embodiment. Indeed, the plate may also extend over the elliptical sections 105, 106, so that they are connected to the interior of the bottom surface 104, and not the perimeter. Threaded screw 110 with a turning handle is preferably positioned 100 mm (or at any convenient measurement) from the top of the tubular section 101 tube, to engage with locking hole 111 protruding from tubular section 101 on the centre line, in a threaded hole. This is used to tighten and fix an upright in position when it has been inserted into inner of tubular section 101.

D-rings 107 are fixed to the outer surface of tubular section, separated by 180°. Preferably they are fixed to the outer surface by welding if the tubular section is metal or plastic, but other securing methods may also be used, according to the materials to be fixed together. Preferably, the D-rings are positioned to be perpendicular to the elliptical sections 105, 106, but may be positioned anywhere on the outer of the tubular section. Preferably additional D-rings may also be provided, and this case the D-rings 107 are typically regularly spaced around the outer surface of tubular section 101. The D-rings are located approx. 20 mm from the top of the tubular section 101, but they may be provided anywhere along the length of tubular section 101. D-rings 107 are used in order to attach supporting guide wires, 109, which attach to the top surface of an inflatable platform, to prevent side to side movement of the umbrella or other item that is being supported. This previous application describes an upright stand that is fully integrated with the securing mechanism. It is desired to provide a portable securing mechanism for floating and inflatable platforms that is stand-alone and is therefore suitable to be used interchangeably with other stands, such as umbrella stands that are already readily available on the market, or stands that may be custom designed for specific purposes, such as supporting a tender whip for example.

Accordingly, the invention seeks to mitigate, alleviate or eliminate one or more of the above-mentioned disadvantages, either singly or in any combination. Aspects of the invention provide for a portable upright stand, for example to be used with a water-based platform, such as a floatable or inflatable platform, to hold an umbrella or other upright structure over the platform.

Of course, there is also the possibility to attach two or more securing mechanisms to a platform, to provide additional shade if required.

The securing mechanism can support a myriad of other products besides an umbrella stand. Other examples include:

a) Support for promotional advertising flags;

b) As supports for uprights positioned along the edge of a platform to create walkway handrails;

c) Support for barriers to enclose a private area;

d) Support for up lights to allow the platforms to be easily used after dark;

e) As a support for a larger shade over one or more platforms,

f) As a support for tables on the platform,

g) as a support for Tender whips.

According to the invention there is provided a securing mechanism suitable for attachment to the side of a floatable or inflatable structure and for securing a stand suitable for supporting an upright, comprising: a first securing section, having a first support region for positioning on or adjacent to the top surface of the structure a second support region for positioning on or adjacent to the bottom surface of the structure, and a central support joining said first and second regions, a second securing section, connected to said first securing section and extending in an opposite direction to said first securing section, having a first support region, a central region and a second support region, wherein said second securing section is for positioning adjacent to a second floatable or inflatable structure; a central fixing area having a top side and a bottom side, connected on the bottom side at or proximate to a first region of at least one of said first and second securing sections, wherein part of said central fixing area can be affixed to a stand for supporting or receiving an upright.

In a preferred embodiment of the invention said first and second securing sections are C-shaped curved securing sections.

In an alternative embodiment of the invention, said second securing section is a C-shaped curved section, and said first securing section has a substantially vertical central section, and said first and second support regions are substantially horizontal extensions, extending from each end of said vertical section.

Preferably, wherein said first securing section further comprises an extension support, extending substantially horizontally from said second support region, to be positioned to be adjacent to said bottom surface of said structure. In a further preferred embodiment of the invention the extension support has a substantially T-shaped perimeter.

In a preferred embodiment of the invention said first and second securing sections are connected to said central fixing area proximate the perimeter of said central fixing area.

Further preferably, said first and second securing sections are arcuate sections and are connected at their common tangent.

In a further preferred embodiment of the invention the first and second securing regions of said second securing section extend and join together to form a continuous circular or elliptical ring to pass around the perimeter of the second floatable or inflatable structure.

In an embodiment of the invention, at least one of said first and second securing sections is a partial section of the inner surface of a cylinder.

Preferably, the invention provides that said first and second securing sections are sections of the circumference of an ellipse or circle, and further comprising third and fourth securing sections that are sections of the circumference of an ellipse or circle, said third and fourth securing sections located at the opposite side of said central fixing area and parallel to said first and second securing sections respectively.

Further preferably, the mechanism also comprises at least one reinforcing rib between one of said first and third securing sections and said second and fourth securing sections.

In an embodiment of the invention, at least one of said first and third securing sections, or at least one of said second and fourth securing sections are complete circles or ellipses; joined by at least one reinforcing rib.

Preferably, said central fixing area is a rectangular or circular plate, further preferably, said rectangular or circular plate has one of more voids in the interior of the plate. In an embodiment of the invention the stand is permanently affixed to the central fixing area, preferably by welding.

In an embodiment of the invention, said central fixing area can be releasably secured to said stand for supporting or receiving an upright to said central securing region. Preferably the central fixing area is provided with one or more receiving holes, for receiving screws or other securing means, to releasably secure said stand to said central fixing area.

Preferably, the invention further comprises a detachable elevation component, on the top surface of said central fixing, to raise the height of the top of the stand above the platform. In an embodiment of the invention the height of the detachable elevation component is adjustable. Preferably, the detachable elevation component is disc-shaped. An embodiment of the invention may preferably further comprise a second extension support, extending substantially horizontally from one of said first securing section or said central fixing area, to be positioned to be adjacent and parallel to said top surface of a floatable structure. Preferably, wherein said second extension support is attached to said detachable elevation component and can be detached from said securing mechanism.

In an embodiment of the invention, the second extension support has the same configuration as the first extension support. Alternatively, the second extension support is shorter than the first extension support. In a further embodiment of the invention, the second extension support is wider than the first extension support.

In an embodiment of the invention, the securing mechanism is formed of metal. Preferably, stainless steel. In some embodiments, the mechanism may be powder coated. Alternatively, the mechanism may be formed of plastic or carbon. In a further embodiment of the invention there is provided an assembly for securing an upright to a floating or inflatable platform comprising a securing mechanism according to any preceding claim and an upright stand to be secured to said securing mechanism.

This invention relates to a securing mechanism used to support a portable upright stand that can accommodate a number of upright objects that can be used for a multitude of purposes. It is quick to put into place (typically less than 2 minutes) and can accommodate umbrellas and shades that already exist on the market. The mechanism is easy to store and maintain. These and other aspects of the invention will be apparent from, and elucidated with reference to, the embodiments described hereinafter.

### BRIEF DESCRIPTION OF THE FIGURES

Further details, aspects and embodiments of the invention will now be described, by way of example only, with reference to the drawings. In the drawings, like reference numbers are used to identify like or functionally similar elements. Elements in the figures are illustrated for simplicity and clarity and have not necessarily been drawn to scale.

FIG. 1 illustrates a prior art inflatable canopy;

FIG. 2 illustrates a prior art bimini arrangement;

FIG. 3 shows a side view of a prior art portable upright stand;

FIG. 4 shows an alternative side view of the prior art portable upright stand;

FIG. 5 shows a front view of the prior art portable upright stand;

FIG. 6 is a rear view of a prior art portable upright stand;

FIG. 7 is a perspective view of a portable securing mechanism according to a first embodiment of the invention;

FIG. 8 is a side view of the portable securing mechanism shown in FIG. 7;

FIG. 9 is a side view of an alternative portable securing mechanism according to the second embodiment of the invention;

FIG. 10 is a perspective view of the securing mechanism of the second embodiment of the invention;

FIG. 11 is a perspective view of the securing mechanism of the second embodiment of the invention with an umbrella stand in place;

FIG. 12 is an alternative perspective view of the securing mechanism of the second embodiment of the invention with the umbrella stand in place;

FIG. 13 is a side view of the securing mechanism of the second embodiment of the invention with the umbrella stand in place;

FIG. 14 is a bottom view of the securing mechanism of the second embodiment of the invention;

FIG. 15 is a perspective top view of the portable securing mechanism with attached umbrella stand in position at the side of a platform;

FIG. 16 is a view of the underside of a securing mechanism of the second embodiment of the invention fixed to a platform;

FIG. 17 is a side of the securing mechanism of the second embodiment of the invention and umbrella stand in place against an inflatable platform;

FIG. 18 is a close-up view of the underside of a platform showing the portable securing mechanism of the second embodiment of the invention in position;

FIG. 19 is another view of the underside of a platform showing the portable securing mechanism of the second embodiment of the invention in position;

FIG. 20 is a perspective view of a portable securing mechanism according to a third embodiment of the invention;

FIG. 21 is an alternative side perspective view of the third embodiment of the securing mechanism;

FIG. 22 is a perspective view of a fourth embodiment of the invention;

FIG. 23 is a top view of the securing mechanism according to a fourth embodiment of the invention;

FIG. 24 is an alternative view of the fourth embodiment of the invention;

FIG. 25 shows an elevation component according to an embodiment of the invention; and

FIG. 26 shows an extension support according to an embodiment of the invention.

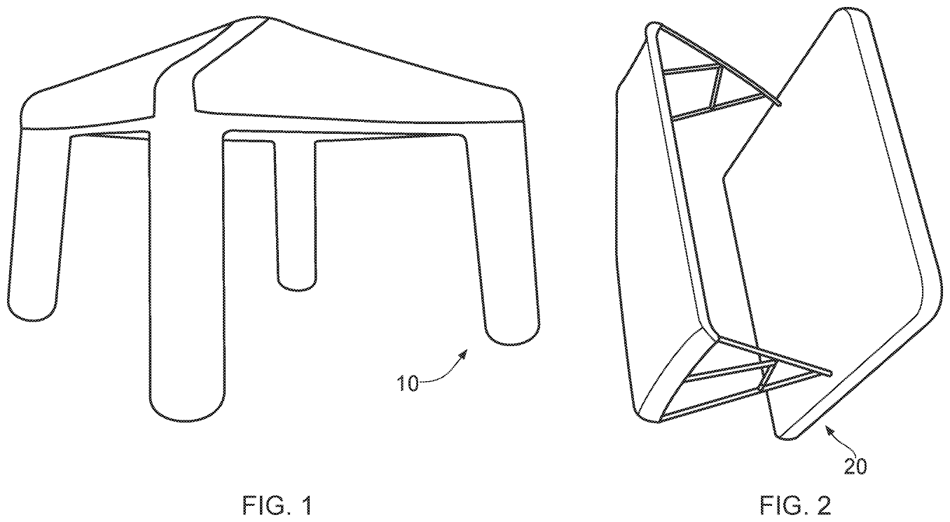

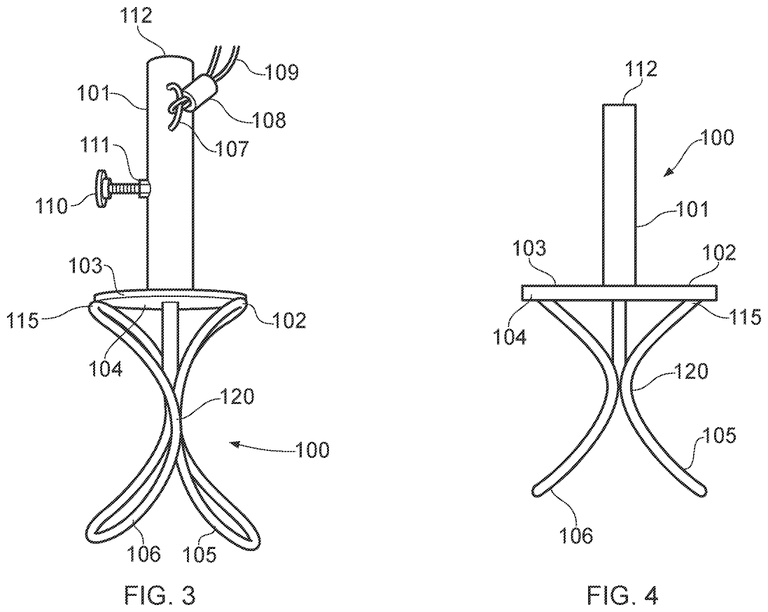

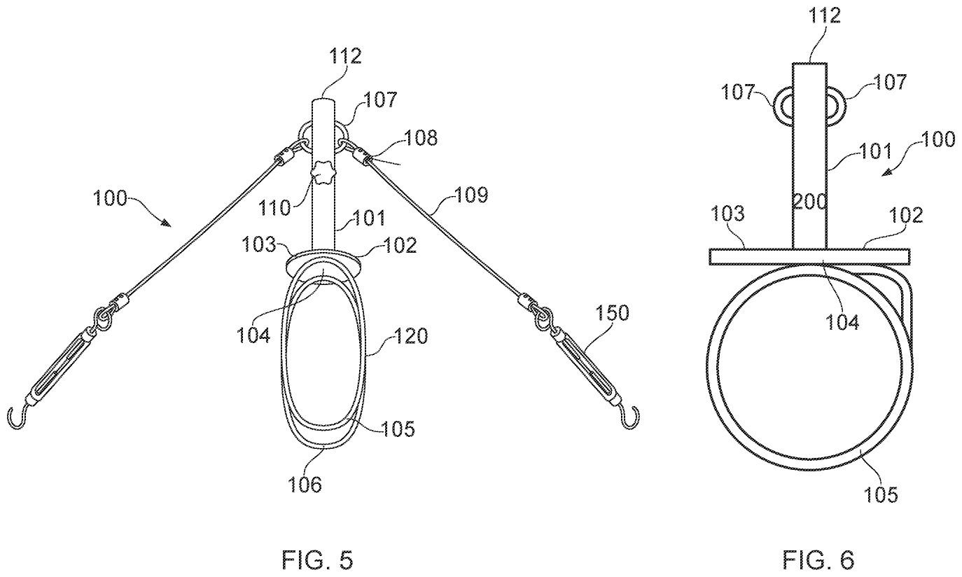

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

As the illustrated examples of the present invention may for the most part, be implemented using components known to those skilled in the art, details will not be explained in any greater extent than that considered necessary as illustrated below, for the understanding and appreciation of the underlying concepts of the present invention and in order not to confuse or distract from the teachings of the present invention.

Although examples of the invention are described with reference to various sizes and shapes of portable securing mechanisms for upright stands, it is envisaged that other sizes and shapes of securing mechanism may benefit from the concepts described herein.

The portable securing mechanism for an upright stand (for supporting an umbrella/sun-shade or any other object with a suitable pole or upright) is designed to be held in place against a floatable or inflatable platform by air pressure when the securing mechanism is positioned between two inflatables, such as a floatable inflatable platform, or inflatable air toggles, or other inflatable or floatable objects.

In an example of the invention, the stand is preferably a stand for an umbrella which will then provide shade to users of the platform. Alternatively, the stand may be for tender whips, or various other items. An existing umbrella stand can then be attached to the mechanism, and used to support an umbrella, and thus provide shade to users of the platform. The strength of the Air Pressure in the inflatable platform, combined with the design of the portable securing mechanism will keep the mechanism fixed in place, and so a stand that is fixed to the securing mechanism will be kept upright. The portable securing mechanism can be kept in place between a platform and an inflatable Air Toggle, using the Air Toggle system as described in GB2531066 to link the platforms.

The operation will be described in detail below, but in summary, the platform is inflated and the portable securing mechanism is positioned along a side of the platform, a deflated Air Toggle is fed through the Air Toggle loops of the platform and the Air Toggle is inflated. The Air Toggle and the platform will hold the securing mechanism in place—pinning it against the wall of the platform with the pressure from the Air Toggle. A pre-existing umbrella or other upright stand can then be fixed, either temporarily or permanently to the securing mechanism, and used for an umbrella or other upright. In some other embodiments of the invention the securing mechanism may be held in place between two platforms, rather than a platform and an air toggle, and ratchet system will be used to hold the two platforms together.

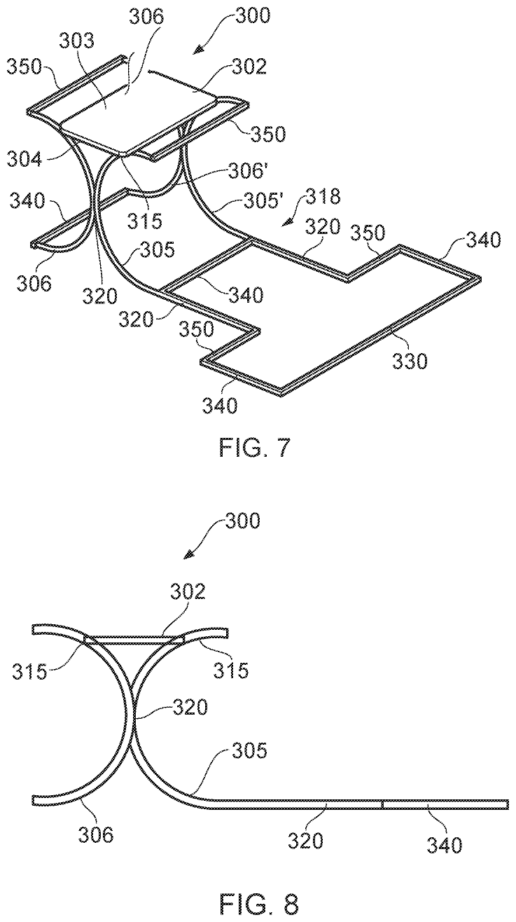

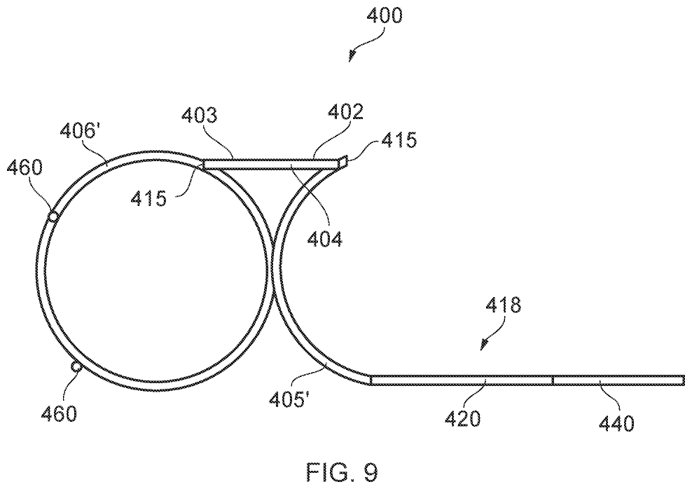

FIG. 7, FIG. 8 and FIG. 9 are alternative view of a first embodiment of the portable securing mechanism 300 for an upright stand. The portable securing mechanism 300 comprises parallel curved arcuate sections 305, 305′; 306, 306′, where sections 305, 305′ are back-to-back with sections 306, 306′, and connected at the common tangent of the two opposed curved sections. In this embodiment of the invention sections 305, 305′ are first securing sections and section 306, 306′ are second securing sections. In this embodiment of the invention, they are continuous circular sections, but they may alternatively be partial sections of a circle. In an embodiment of the invention, the centre of the sections 305, 305′, 306, 036′ is considered as a central support that will abut the side of a platform, and the ends of the curved sections 305, 305′, 306, 306′ are first and second support regions that can be positioned on or adjacent to the top and bottom surface of the platform or other floatable inflatable structure. In a preferred embodiment of the invention the first and second securing sections 305, 305′, 306, 306 are C-shaped curved securing sections. There is also a central fixing area 302 typically a rectangular plate, with top surface 303 and bottom surface 304, alternatively the central fixing area may be a circular plate, or have some other shape. As shown, central plate 302 is a solid plate, but it may alternatively be a rectangular rim around the circumference, with a void in the interior of the central plate 302. In some embodiments of the invention, the plate may also curve downwards at the edge connected to the curved section 406.

The bottom ends of the parallel curved sections 305, 305′; 306, 306′, are connected via reinforcing ribs 340. In this embodiment, each curved section 305, 305′, 306, 306′ is connected to the plate 302 at connection 315, proximate to the perimeter of the plate 302, preferably by welding, if the components are metal, or other suitable fixing methods for components made from other materials. Each curved section 305, 305′, 306, 306′ further extends out above and past the central support plate 302. The top ends of parallel curved sections 305, 305′ and 306, 306′ are connected by reinforcing rib 350. As shown, the reinforcing ribs extend between the ends of parallel curved sections 305, 305′; 306, 306, but they may extend between any two points of the parallel, sections, preferably points that are at directly opposed locations. In further embodiments of the invention, one or more of the reinforcing ribs may also extend further out from one or both sides of the securing mechanism. Curved sections 305, 306 and 305′, 306′ are position back-to-back to curve away from each other and are connected together 320, preferably by welding at the tangent where the curves touch.

Preferably, the parallel curved sections are semi-circular and the shape defined by the parallel curved sections 305, 305′; 306, 306′ and the reinforcing ribs 340, 350, is that of the outer perimeter of half cylinder. This securing mechanism 300 also has extension support section 318, that extends substantially horizontally from the ends of curved sections 305, 305′ here they are joined by reinforcing rib 340. In the embodiment of the invention as illustrated, the extension support section 318, comprises first extensions 320, extending vertically from the ends of the curved section 305, 305′, at the end of first extensions 320 the extension support section 318 comprises second extensions 350, perpendicular to the first extensions 320 and parallel to rib 340. These are connected to third extension sections 340 (parallel to sections 320), and joined by section 330. Thus, sections 320, 330, 340 and 350, form a T-shaped extension support 318 that extends from the bottom of the portable securing mechanism 300. In use (as illustrated later in the specification), the T-shaped extension support 318 will rest against the bottom surface of a floatable/inflatable platform to provide a counter balance to a stand or object, such as an umbrella or a tender whip that is inserted into the stand. This will ensure the object in the stand generally remains upright in adverse weather conditions, such as high winds for example. This counter balance may be particular useful when a heavy stand is affixed to the securing mechanism 300 for example.

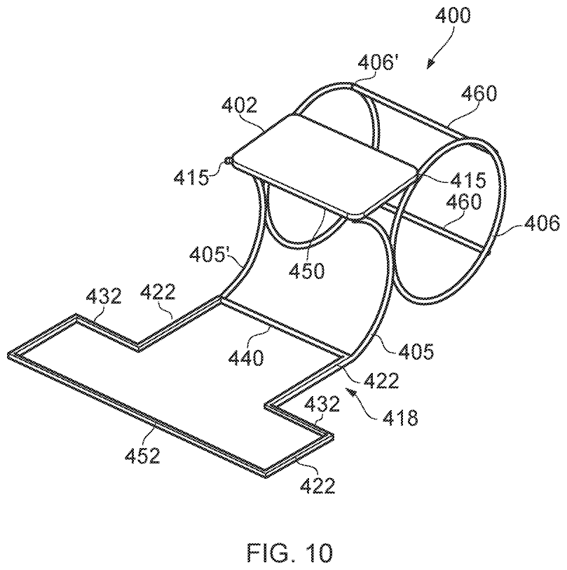

FIG. 9 and FIG. 10 show a portable securing mechanism 400 according to a second embodiment of the invention. Features that are the same as the first embodiment will not be described in great detail and like elements have like reference numerals. The central fixing area 402 is a rectangular plate as described above for the first embodiment of the invention. In some examples of the invention the central plate may be circular, or may also curve downwards on one side of the plate, so that when the securing mechanism 400 is in place around an Air Toggle, it will curve around the Air Toggle.

This second embodiment has first parallel curved or arcuate sections 405, 405′ that correspond to curved sections 305, 305′ of the first embodiment, as the first securing sections, and have corresponding reinforcing rib 440, and are connected to the supporting plate 402 as previously described. As for previous embodiments, sections 405, 405′ are back to back with parallel curved or arcuate sections 406, 406′ where sections 406, 406′ are the second securing sections, and are connected at the tangents where the opposed sections meet. In this embodiment sections 406, 406′ are complete circles that abut the sections 405, 405′, alternatively sections 406, 406′ may be elliptical in shape. As shown, the circles 406, 406′ are connected to the bottom surface of central support plate 402 at 415. Preferably, join 415 is towards the top of the section 405, 405′, but it may be connected at other places along the curved sections 405, and 406. In some embodiments of the invention, there may be an additional supporting rib (not shown) alongside edge 415 that extends further along either end of edge 415 to provide additional support. The two parallel circles are connected by at least one bracing rib 460 that extend between the parallel circles 406, 406′. Similarly, the curved sections 405, 405′ are connected by support rib 440. Typically, the support ribs are positions so that they are close to the bottom of the sections, away from the top plate 402, but they may be positions in other locations, closer to the central plate 402. Preferably the supporting ribs 440, 460 are parallel to the central plate 402, but they may be positioned in different orientations. This securing mechanism 400 also has extension section 418, that extends substantially horizontally from the ends of curved sections 405, 405, where they are joined by rib 440. In the embodiment of the invention as illustrated, the extension support section 418, comprises first extensions 422, extending vertically from the ends of the curved section 405, 405′, at the end of first extensions 422 the extension support section comprises second extensions 432, perpendicular to the first extensions 422 and parallel to rib 440.

These are connected to third extension sections 442 (parallel to sections 422), and the third extension section 442, and joined by section 452. Thus, sections 422, 432, 442 and 452, form a T-shaped extension support that extends from the bottom of the portable securing mechanism 400. In use (as illustrated later in the specification), the T-shaped extension support will rest against the bottom surface of a floatable/inflatable platform to provide a counter balance to a stand that may be affixed to the securing mechanism. This counter balance may be particular useful is if a heavy stand is affixed to the securing mechanism 300, 400. As shown, the extension support section 418 is T-shaped, but other shapes may also be possible, as long as they are wide and long enough to provide a counterbalance to the weight of the stand that will be affixed to the securing mechanism. Preferably, the extension support section 418 is shaped to evenly distribute the weight of the mechanism and under the platform, and will rest against, but not dig into the bottom surface of the platform, thus preventing any damage to the platform from the extension support section 418. In a further embodiment of the invention the securing mechanism may also be provided with a second extension support that extends from the top of the securing mechanism 300, 400 to provide further support.

This additional extension, would rest against the top surface of the platform, and typically will be parallel to the first extension support section. In a first example of the invention the second extension support section may have the same configuration as the first extension support section . Alternatively, the second extension support section, may be shaped to be less intrusive, and more aesthetically pleasing, so maybe shorter and/or wider than the first extension support section, and may have a semi-circular shape for example. In some embodiments of the invention, the second extension support section may be shaped as a pleasing design feature, for example, as a fan shape, or shaped to minimise the space it will cover on the top of the platform, so the majority of the platform remains useable.

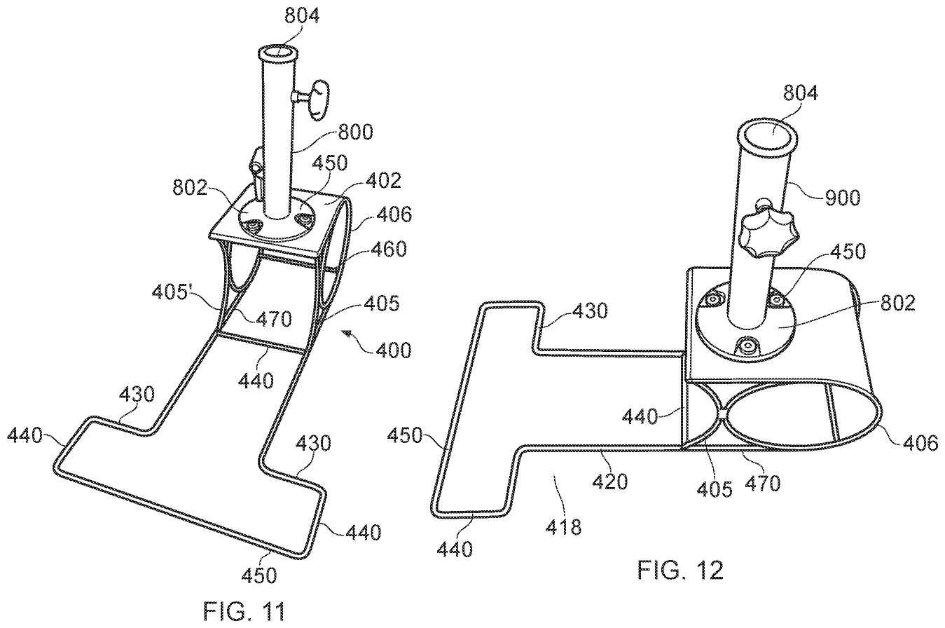

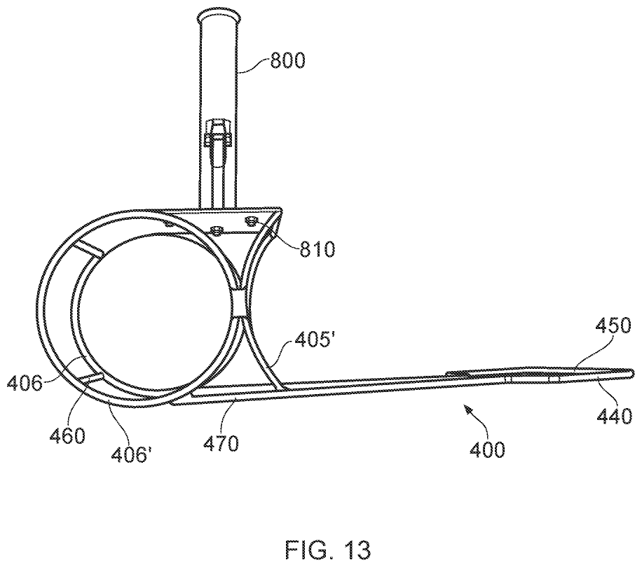

FIG. 11, FIG. 12 and FIG. 13 show the securing mechanism 400 with an umbrella stand 800 held in place on the securing mechanism 400. The securing mechanism 400 is the same as previously described, but these figures also show additional support rib 470, that joins the extension section 418 to the section 406, 406′. This will provide additional support and stability to the securing mechanism 300, 400.

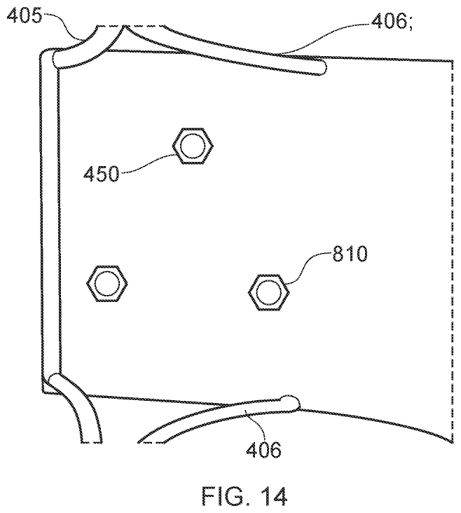

In operation, the securing mechanism 300, 400 will be put in position against a floatable/inflatable platform, and an umbrella stand 800 may be fixed to the central plate 302, 402. In an example of the invention stand 800 may be affixed before the securing mechanism 300, 400 is put into position against the platform 700, or alternatively, the stand 800 may be affixed to the securing mechanism after the mechanism is put in position with regard to the platform 700. In an example of the invention, the base plate 802 of the umbrella stand 800 may be screwed to the central plate 402, using screws 450, that pass-through holes in the base of the stand, through holes 450, in the central plate 302, 402 and are held in place by securing nuts 810 this is shown in FIG. 14, where the holes 450, and nuts 810 are indicated. As shown, the central plate is provided with 3 securing holes, but may have any number of securing holes, say 4 or 5, according to the configuration of the stand that is to be secured to the central plate 302, 402 of the securing mechanism 300, 400. In this manner, the umbrella stand 800 can be easily removed from the securing mechanism 300, 400, and so used in different securing mechanisms, for example as the sun moves, or the users of the platform move around.

Alternatively, the umbrella stand 800 may be permanently fixed to the central plate 302, 402 by welding for example, if the components are metal, or use of suitable adhesive materials if the plate and/or stand are made or non-metallic material, or other suitable fixing means If the central plate 302, 402 of the securing mechanism is not a solid plate , but instead is merely the rim or other partial section of the plate, then the base plate 802 of the umbrella stand 800 may be fixed to the perimeter of the central plate 302, 402 in a similar manner, either temporarily or permanently. As shown, all or part of the securing mechanism 300, 400 may be formed of metal, preferably stainless steel, alternatively, parts of the securing mechanism 300, 400 may be formed of heavy-duty plastic that is designed for used in sea water, or carbon, or any other material than would be resistant to corrosion in seawater. In some embodiments of the invention, the securing mechanism may be powder coated to prevent it from rusting.

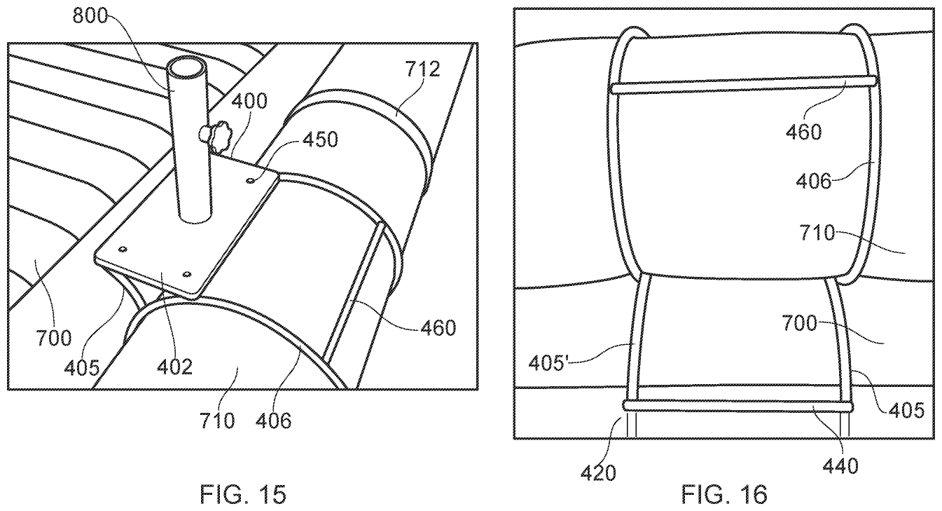

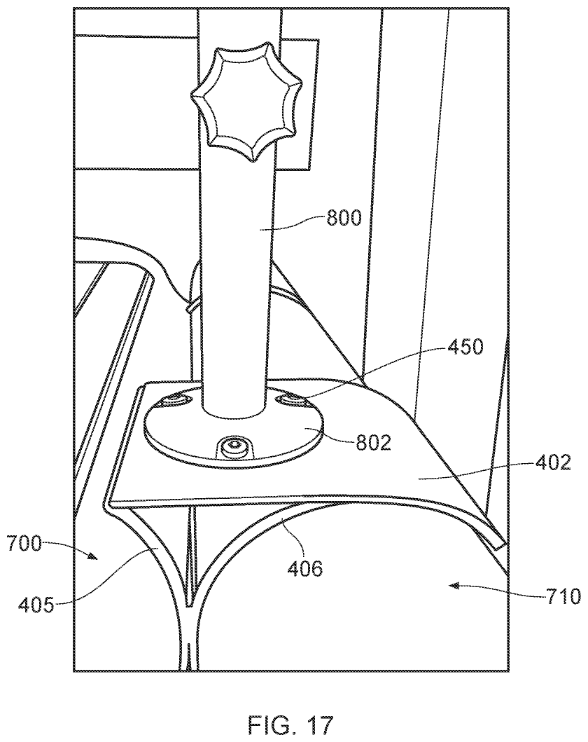

FIG. 15, FIG. 16 and FIG. 17 are various different views of the securing mechanism 400, with attached umbrella stand 800 in position between a platform 700 and an Air Toggle 710. As shown, the air toggle 710 passes through the circular sections 406, and the curved sections 405 pass around the end of a platform 700, and are shaped to hug the sidewall of the platform 700. The securing mechanism 400 is held securely in position between the Air Toggle 710 and platform 700. In this example of the invention, the stand 800 is screwed to the plate 402 using screws 450, secured with nuts 810 held against the underside of the central plate 402. The air pressure in the Air Toggle 710 and platform 700 will hold the securing mechanism 400 in place, and maintain the stand 800 in an upright position.

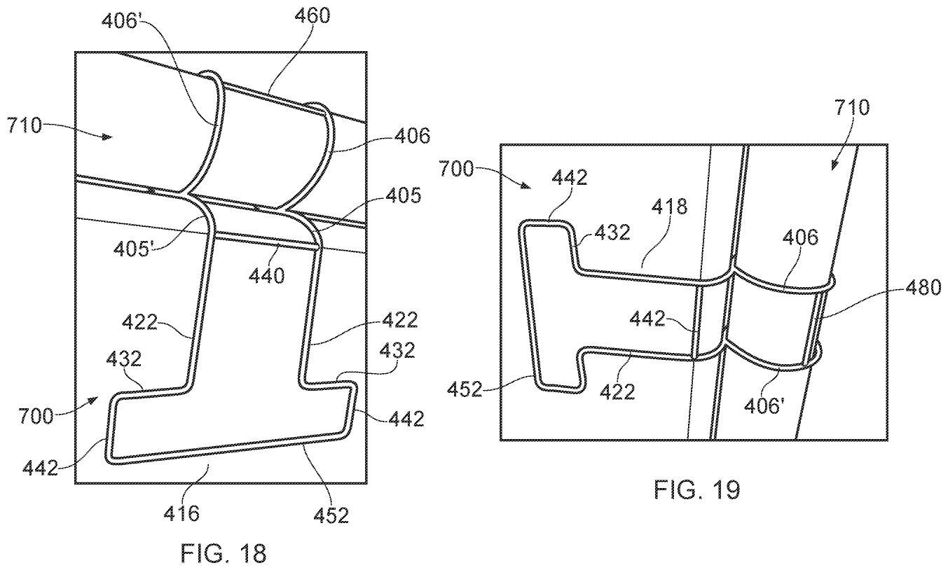

FIG. 18 and FIG. 19 show the underside of the platform 700 and Air Toggle 710 with the securing mechanism 400 in position. As described above, the Air Toggle 710 passes through the circular sections 406, and 406′, and the curved sections 405 405′ of the securing mechanism 400 are flush with the side of the platform 700. The first extension support 418 of the securing mechanism 400 extends along the bottom surface of the platform 700, and helps to secure the securing mechanism 400 in place between the platform 700 and the Air Toggle 710. As discussed above, this provides a useful counterbalance, if the stand 800 that is affixed to the securing mechanism 400 is heavy, and may otherwise, sway in difficult weather or sea conditions for example.

In all of the embodiments as shown in FIG. 9-19, the first securing region, that is next to the platform is curved, and the second securing region, extending in an opposite direction is also curved. In a further example of the inventions these embodiments may be provided with an additional vertical support (not shown) extending between the first and second regions, to provided additional structural support, and assistance with load-bearing when the mechanism 300, 400, is in use. Typically, the height of the additional vertical support will be the same, or smaller than the height of the first and second securing sections.

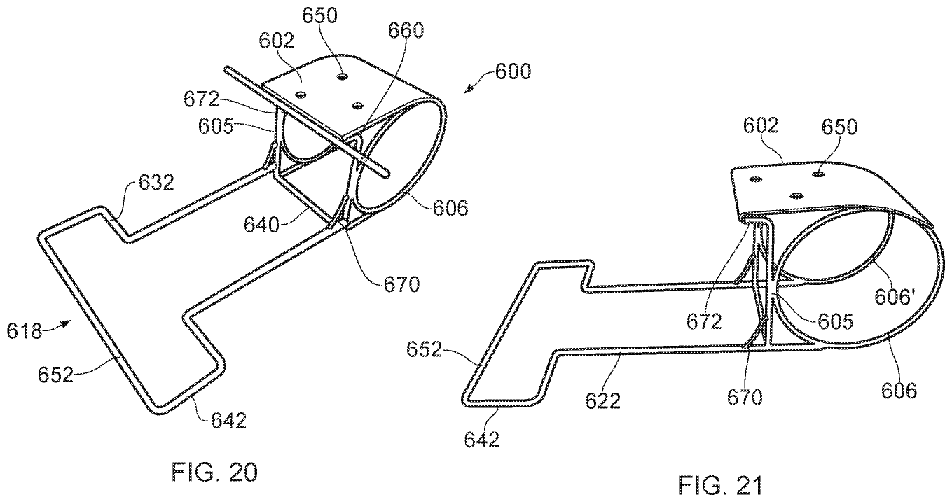

FIG. 20 and FIG. 21 are alternative views of a securing mechanism according to a third embodiment of the invention. Sections of the mechanism that are the same as sections of the previous embodiments have similar reference numerals, so for example, in this embodiment of the invention the central fixing area is a plate is 602, with holes 650, and the T-shaped extension support section 618 is comprised of sections 622, 632, 642 and 652. As before, the plate 602 is rectangular, but other embodiments of the invention may have a different shaped central fixing area Also, second securing sections 606, 606′ are circular but they may alternatively be elliptical Also shown is bar 660, at the side of the plate 650 that is above the vertical support 640. In a preferred example of the invention bar 660 is longer than the length of the plate 640, but the bar 660 may be shorted or longer than the bar 660 as shown in the figure. The bar 660 is optional for the invention, but when used, can provided an additional means of holding the securing mechanism 600 in place against the platform 700.

However, this embodiment is distinguished from the previous embodiment of the invention in the configuration of the first securing section. In the previous embodiments of the invention, the first securing section, 305, 405, was curved, to abut against the side of the platform 700. In this embodiment of the invention, the first securing section is comprised of vertical central support 605, and horizontal support sections 670 , 672, that extend from either end of the vertical support 605. In use, the vertical central support section 605 will abut the side wall of the platform 700, top horizontal support 672 will be above and parallel to the top of the platform 700, and the bottom horizontal support 670 will be below and parallel to the bottom of the platform 700. In this example of the invention the top and bottom horizontal supports 670, 672 are straight, but in some other embodiments of the invention, then may be provided with curved ends, curving inwards towards to other, to assist in positioning the securing mechanism 600 in position as close against platform 700 as possible. The second securing section, defined by circular rings 606, 606′ work as described above, and an Air Toggle 710 will pass through the interior of these sections 606, 606′ to be held in place using the Air Toggle loops 712 on the platform 700. This embodiment of the invention also has the T-shaped extension support 618, formed from sections 622, 632, 642 and 652. The extension support 618 is the same as described previously with respect to the other embodiments of the invention.

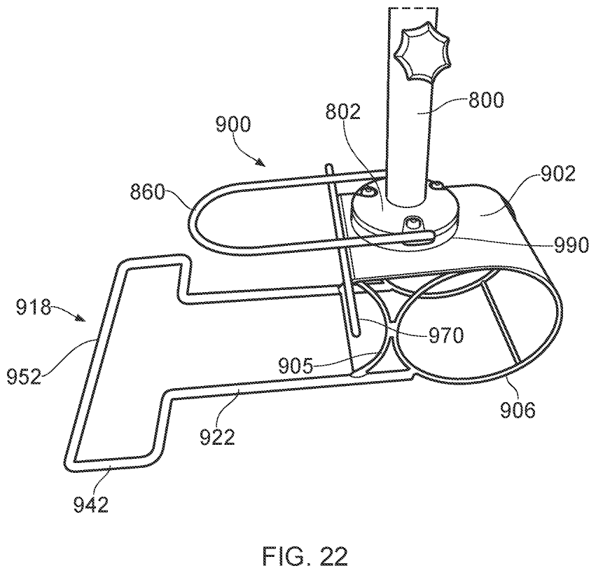

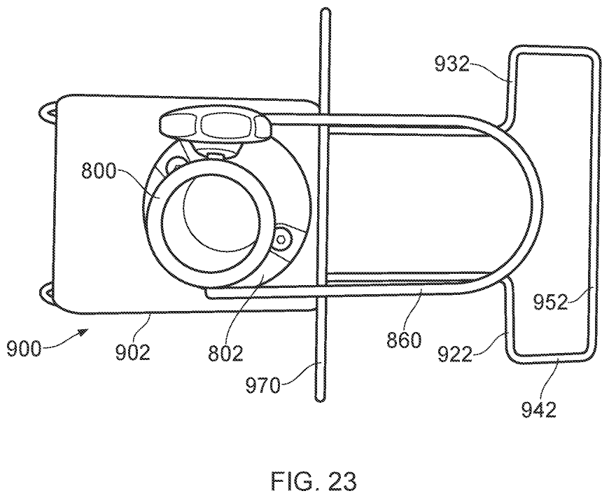

FIG. 22 and FIG. 23 describe a fourth embodiment of the invention. In this embodiment the securing mechanism 900 is generally the same as the securing mechanism 400 describe above (so like elements will have like reference numeral 900 for the overall mechanism, 902 for the central plate etc). However, this embodiment of the invention has an additional upper extension support 860 to provide additional stability and support when the securing mechanism 900 and stand 800 are in position against a platform 700. Preferably, the upper extension support extends substantially horizontally from the securing mechanism 900, and in use will be positioned adjacent and parallel to the top surface of the platform 700. In the preferred embodiment of the invention, the additional extension support 860 is U-shaped, and defined by a perimeter than has an empty interior, thus minimising the amount of material in this component. In alternative embodiments of the invention, the extension support 860 may have a different shape, and the interior of the support by be solid, rather than merely defined by the perimeter as shown in the figure. On the edge of central plate 902 that is next to the first securing region 905 is supporting rib 970, as shown this extends to be wider than the securing mechanism 900, but the length may be varied, so it may be the same width as the securing mechanism, or it may extend further on one side of the mechanism than the other side.

As shown, the securing mechanism 900 also has an elevation component 990 between the central top plate 902, and the stand 800. Preferably, the elevation component 990 is a circular shaped elevation disc, but other shapes of the elevation component 990 may be possible, this disc shape is preferred for aesthetic reasons. The height of the elevation component 990 can be varied, so that the stand 800 can be positioned higher or lower on the securing mechanism 900, to ensure the stand 800 is in the optimum location with respect to the platform 700. In this embodiment of the invention the upper extension support 860 is connected to the elevation component 990, and so can easily be removed from the mechanism when the elevation component 990 is removed from the mechanism 900. Alternatively, the upper extension support 860 may be permanently fixed to the securing mechanism 900, and may extend from the central fixing area 902, or from the first region of the first securing section 905. Screws 450 will pass through holes 802 in the base of the stand 800 and holes in the elevation component 990, holes 950 in the top plate 902, to be secured by nuts 810, on the underside of the top plate 802. The upper extension support 860 may alternatively be affixed directly to the central plate 902, either on the top or bottom surface of the plate. Typically, the upper extension supports 860 has a smaller footprint compared to the original bottom extension support 918, but it can have other shapes and sizes, and may be the same shape and size, or may be bigger than the bottom extension 918, for example, it may be significantly wider and shorter than the other extension support 418, 618, 918, to extend across the length of the platform 700, but not significantly into the platform 700, where it may reduce the available space on the platform.

In a further example of the inventions this embodiment of the invention may also be provided with an additional vertical support (not shown) extending between the first and second securing regions, to provided additional structural support, and assistance with load-bearing when the mechanism 900, is in use. Typically, the height of the additional vertical support will be the same, or smaller than the height of the first and second securing sections.

Preferably, the lower extension support, and/or the upper extension support are designed and shaped so that the load on the securing mechanism 300, 400, 600, 900 will be spread over the platform, and not concentrated in a small area on the platform. This load spreading will also prevent the extension support from digging into the platform, and the possible problems this would result in.

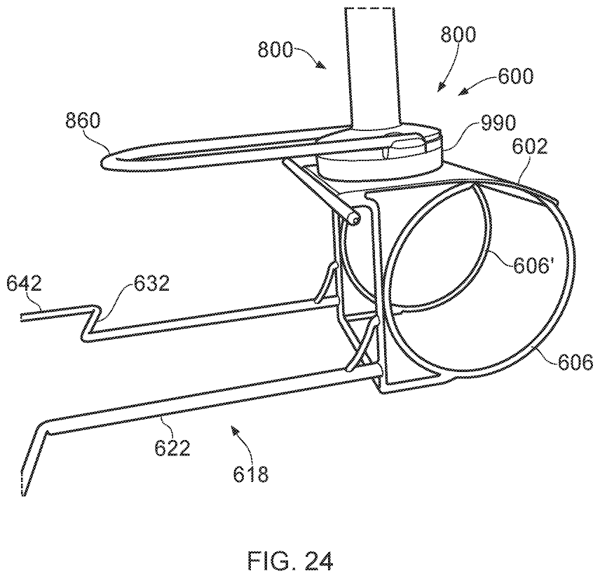

FIG. 24 is a further embodiment, which is a modification of the third embodiment as already described. Features in common with the third embodiment will not be described here. As shown, this modification to the third embodiment also includes the upper extension support 860, and the elevation component 990 as described above with reference to FIGS. 22 and 23. This will function in the same was as for these earlier figures, and as previously, although this figure shows the additional extension support 860 connected to the base 802 of the umbrella stand 800, it may alternatively be connected to the top plate 602.

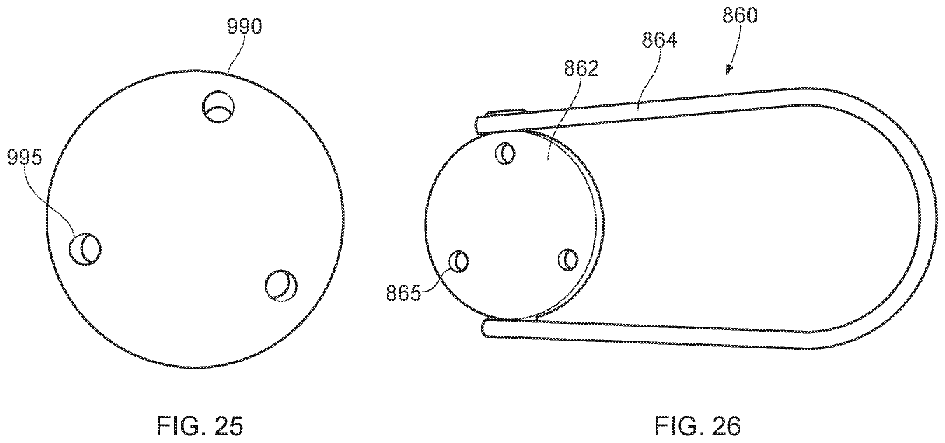

FIG. 25 and FIG. 26 show the additional extension support 860, and elevation component 990 when they are removed from the mechanism 300, 400, 600, 900. Although these elements of the invention are preferably detachable, they may alternatively be fixed to the central fixing plate 302, 405, 602, 902 if required. As shown, the elevation component 990 is provided with holes 995. These will align with the holes 450 in the central fixing plate 402, 602. 902, and also the holes in the base of the stand 800. The extension support 860, has U-shaped extension 864, affixed to central extension plate 862, which is provided with fixing holes 865. In use, the elevation component 990 will be placed in the top surface of the central fixing plate 402, 602, 902, with holes 995 aligned with holes 450 in the fixing plate. The extension support 860 will be placed in top of the elevation component 990, and the stand 800 will be placed on the top of the extension support. The holes for all three components will be aligned so that screws can pass through all the holes, and be secured with nuts 810 to hold the stand 800 in position on the securing mechanism 300, 400, 600, 900.

In all of the above embodiments, the bottom extension support 318, 418 618, 918, is shown with a T-shaped perimeter, and open space that is bound by the perimeter. It will be understood that this extension support may have a variety of different shapes, and the T-shape is merely an example, and any shape is possible, as long as the extension support acts as a counter balance, and does not dig in or mark the inflatable it is against. In a further example of the invention, the extension support 318, 418, 618, 918, may be provided as a solid region, so extension support would be a solid sheet with edges 340, 320,350,340,330, 340, 320, and similarly for other extension supports 418, 618, 918.

In the various embodiments of the invention the central fixing area is preferably a rectangular or circular plate, with a solid interior. In alternative embodiments of the invention the central fixing area may have a different shape, and may also be defined by a perimeter that does not have a solid interior.

The various different securing mechanisms 300, 400, 600, 900 may also be a component in an assembly for securing a stand. Preferably the assembly will comprise a securing mechanism as described above and an upright stand to be secured to the mechanism.

In all of the above various embodiments described above the securing sections under the central support plate are defined by the edges, and the interior bound by the edges is empty. In alternative embodiments however, it is possible that all of the curved sections may be solid. In this case, in the first embodiment curved sections 305, 306 are solid sections, similarly, in the second embodiment, the curved sections, 405, 405′; 406,406′, supporting rib 440 and bottom surface 404 of central plate 402 may be the perimeter of a solid section that is partial surface of a cylinder. Similarly, for the other embodiments, the curved sections may define solid curved sections, rather than simply defining the perimeter of a curved section/cylinder that does not have a partial/total interior. Alternatively, the securing mechanism may be provided with further strengthening sections between 405, 405′ and 406, 406′, to prevent bending of these parts of the mechanism. In the various embodiments described above the portable securing mechanism 300, 400, 600, 900 is made of metal. Preferably the metal is stainless steel. The portable securing mechanism may also be coated metal, for example with a rubber, plastic or powder coated coat, or an enamel coating. In this case, the coating may prevent the portable upright stand from rusting, and potential transferring rust or other material from the portable upright stand onto the platform 700 or Air Toggle 710 that it is connected to. Alternatively, the portable upright stand may be made of other material such as UV resistant moulded plastic, or carbon. Indeed, it may be that some parts of the mechanism 300, 400, 600, 900 are metal and other parts are formed of other material such as plastic. Basically, as long as the material is of suitable strength and resistant to exposure to sea or other weather conditions.

In all of the various different embodiments as described the Air Toggle loops 712 are a loop of fabric (typically they are 25 mm wide and approximately 57 cm long) when they are not in use, they are held in place on the side of the platform 700 with a Velcro® flap (not shown) about 8 cm in length-the dimensions of the flap and loop may vary if the dimensions of the platform 700 are changed. The Air Toggle loops 712 could also be formed by bungee or other material, as long as they can loop round to secure the Air Toggle 710 and hold it in place. When the Air Toggle 710 is used, the Velcro (RTM) flap is released on each Air Toggle loop 712 to be used and the Air Toggle loops 712 pull out, the deflated Air Toggle is fed through all the Air Toggle Loops 712 and inflated, thus fitting round and holding in place the inflated Air Toggle 710. Air Toggles 710 are designed so that platforms 700 can link to other platforms or other floating systems with the Air Toggle linking system as described in GB Patent application number 1319142.4.

The Air Toggle linking system works to link two platforms 700 by releasing the Air Toggle loops 712 on the first platform along with the Air Toggle loops 712 on the second platform 700. A deflated Air Toggle 710 is inserted through all of the released Air Toggle loops 712 for both platforms, thus holding the two platforms together, then inflating the Air Toggle 710 for an entrapment free connection.

The Pressure between the platform 700 and the Air Toggle 710 (typically 5.5 psi, but could be less, as long as it is sufficient to hold the mechanism in pace) holds the portable securing mechanism 300, 400, 600, 900 in place between the platform 700 and the Air Toggle 710. This occurs because the sections 305, 306, 405, 406, are secured by the air pressure within the platform 700 and the Air Toggle 710.

The deflated Air Toggle 710 is passed through the released Air Toggle loops 712 of platform 700. The deflated Air Toggle 710 is also passed through the middle of circular sections 406 and 406′ of the portable upright stand 400. The Air Toggle 710 and the middle of circular sections 406 & 406′ and the Air Toggle Loops 712 will have matching diameters, so that when the Air Toggle 710 is inflated it is held snugly within the Air Toggle loops 712 and circular sections 406, 606, 906. Preferably this diameter is 20 cm but other diameters may be possible. This snug fit between the air toggle 710, the circular section 406 & 406′, 606, 606′, 906, 906′ and the platform 700 will keep the portable securing mechanism 400, 600, 900 firmly in place, and maintained in an upright position, without the need for extra securing fixings.

When the platform 700 and Air Toggle 710 are inflated, and the portable securing mechanism 300, 400, 600, 900 is positioned between them, then circular sections 406, 606, 906 are secured as discussed above, passing around inflated Air Toggle 710, and the other curved sections, 405 & 405′, 605, 605′ 905, 905′ are a snug fit against a side or an end of the platform 700. Air Toggle loops can be provided on all sides of the platforms and therefore the portable upright stand can be positioned anywhere on the perimeter of platform, on any side or end of the platform 700. The curved sections 405 & 405′ will be sized to provide a snug fit against the side of the platform 700, typically 20 cm high. The supporting rib 440 is positioned on the portable upright stand 400 so that it will sit against the underside of the platform 700 and provide additional security for holding the portable securing mechanism 400 in place against the platform 700. Supporting rib 440 also keeps curved sections 405 & 405′ braced apart at even distances. The stand 800 may be permanently or temporarily affixed to the securing mechanism 300, 400 before or after the mechanism 300, 400 is positioned in plate with respect to the platform. Clearly, if the stand 800 is to be permanently affixed to the securing mechanism, such as by welding, then this should be done before the mechanism is positioned next to the platform 700, but if the stand is to be temporarily fixed, then the securing mechanism 300, 400, 600, 900 may be positioned against the platform 700 and then the stand 800 screwed to the plate 302, 402, 602, 902 of the securing mechanism if required.

To support the portable securing mechanism 300, 400, 600, 900 a platform 700 or other supporting structure needs to be fully inflated. The portable securing mechanism 300, 400, 600, 900 is positioned in place where required alongside any side of the platform 700. The Air Toggle 710 is fed through one of the Air Toggle loops 712 near the portable securing mechanism 300, 400, 600, 900 through circular sections 406, 606, 906 of portable securing mechanism 400, 600, 900 and then finally though the next Air Toggle loop 712. If there are more Air Toggle loops 712 on one side of the platform 700 and a longer Air Toggle 710 is used, the Air Toggle 710 will be fed through more Air Toggle Loops 712, as long as there is at least one Air Toggle Loop 712 positioned either side of the portable securing mechanism 400, 600, 900. The Air Toggle 710 is then inflated to full pressure (typically 5.5 psi), bracing the portable securing mechanism 400, 600, 900 into position. Umbrellas or other upright structures can then be placed into the portable upright stand 400, 600, 900 and secured into place. The Air Toggles 710 and Air Toggle loops 712 as described above may be used with any of the embodiments of this invention.

The portable securing mechanism 300 400, 600, 900 may be positioned anywhere along any side of a platform, between a platform 700 and an Air Toggle 710 as long as there is at least one Air Toggle Loop 712 either side of the securing mechanism 300, 400, 600, 900. Feeding the deflated Air Toggle 710 through the circular piece 406, 406′, 606, 606′, 906, 906′ of the portable securing mechanism 400, 600, 900 then inflating the Air Toggle 710, allows for the portable securing mechanism 400, 600, 900 to be supported in an upright position by the inflated Air Toggle 710 and without the need for additional secondary support from wire chain and D-ring points. The sizes of Air Toggle 710 can vary, for example, they may be 0.8 m, 1.5 m, 2 m, 2.5, 3.5 m, 4 m, 4.5 m in length but they can be any desired length according to the size of the platform they will fit with. Air Toggles 710 can also vary in diameter in this example they are 20 cm, however they can be any size to match the size of the platform Alternatively, the Air Toggle 710 may be replaced by another inflatable support, that is sized to fit with the Air Toggle loop 712, and that may, for example, be an L-shaped support, or other inflatable support formed of one or more components with any other shape, where one of the components is positioned at an angle that may be between between 45° to 135° to the other component. In all of the embodiments, the portable securing mechanism 300, 400, 600, 900 can be attached to a single platform 700, and just requires a second support, such as the Air Toggle 710, to hold the portable securing mechanism 300, 400, 600, 900 securely in position between the platform and the second support. Preferably, the Air Toggle 710 will be held in place by Air Toggle loops 712 but there may be other means of securing the second support in position with respect to the platform 700. An Air Toggle 710, or other securing means can be used to link platforms 700 together. Therefore, the portable securing mechanism 300, 400, 600, 900 can be positioned in between any linking platforms or other inflatable such as NautiBuoy SEABOB and Jet-ski docks, preferably using the Air Toggle System to hold it in place. In this way, the portable securing mechanism, 300,400, 600, 900 can be positioned between a platform 700 and a NautiBuoy SEABOB dock and jet ski dock and positioned between the linking of any two inflatables either using the Air Toggle linking system or other securing means.

As described above, the securing mechanism is typically used to hold an umbrella over a floating platform. However, in some embodiments of the invention the securing mechanism may alternatively be used to support a pole that maybe supporting an awning over a floating platform, where the awning is also affixed to a pole on a boat, so the awning is providing shade over the boat and the adjacent platform. In this case, if the awing is square or rectangular for example, then two corners of the awning may be fixing to poles on the boat, and the other two corners of the awning may be fixed to poles in stands held in position in securing mechanism as described above.

In the forgoing specification, an invention has been described with reference to specific illustrated examples. It will, however, be evident that various modifications and changes may be made therein without departing from the scope of the invention as set forth in the appended claims.

The connections as discussed herein may be any type of mechanical connections. The sizes and locations of particular components need not be exactly as shown, as the drawings and description enable a skilled person to replicate the concepts described herein.

Any arrangement of components to achieve the same functionality is effectively ‘associated such that the desired functionality is achieved. Hence, any two components herein combined to achieve a particular functionality can be ‘associated with’ each other such that the desired functionality is achieved, irrespective of architectures or intermediary components. Likewise, two components so associated can also be viewed as being ‘operably connected’, or ‘operably coupled’ to each other to achieve the desired functionality.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Thus, an improved solution is described for a portable securing mechanism for an upright support, preferably for use with a floatable or inflatable platform, to hold an umbrella or other upright structure. The inventor of the present invention has recognised and appreciated a number of problems with existing designs, which have been substantially alleviated with the concepts described herein.

1-31. (canceled)

32. A securing mechanism suitable for attachment to the side of a floatable or inflatable structure and for securing a stand suitable for supporting an upright, comprising:
a first securing section, having a first support region for positioning on or adjacent to the top surface of the structure a second support region for positioning on or adjacent to the bottom surface of the structure, and a central support joining said first and second regions;
a second securing section, connected to said first securing section and extending in an opposite direction to said first securing section, having a first support region, a central region and a second support region, wherein said second securing section is for positioning adjacent to a second floatable or inflatable structure; and
a central fixing area having a top side and a bottom side, connected on the bottom side at or proximate to a first region of at least one of said first and second securing sections, wherein part of said central fixing area can be affixed to a stand for supporting or receiving an upright.

33. A securing mechanism according to claim 1, wherein said first and second securing sections are C-shaped curved securing sections.

34. A securing mechanism according to claim 1, wherein said second securing section is a C-shaped curved section, and said first securing section has a substantially vertical central section, and said first and second support regions are substantially horizontal extensions, extending from each end of said vertical section.

35. A securing mechanism as claimed in claim 1, wherein said first securing section further comprises an extension support, extending substantially horizontally from said second support region, to be positioned to be adjacent to said bottom surface of said structure.

36. A securing mechanism according to claim 4, wherein the extension support has a substantially T-shaped perimeter.

37. A securing mechanism according to claim 1, wherein said first and second securing sections are connected to said central fixing area proximate the perimeter of said central fixing area.

38. A securing mechanism according to claim 1, wherein said first and second securing sections are arcuate sections and are connected at their common tangent.

39. A securing mechanism according to claim 1, wherein the first and second securing regions of said second securing section extend and join together to form a continuous circular or elliptical ring to pass around the perimeter of the second floatable or inflatable structure.

40. A securing mechanism according to claim 1, wherein at least one of said first and second securing sections is a partial section of the inner surface of a cylinder.

41. A stand according to claim 1, wherein said first and second securing sections are sections of the circumference of an ellipse or circle, and further comprising third and fourth securing sections that are sections of the circumference of an ellipse or circle, said third and fourth securing sections located at the opposite side of said central fixing area and parallel to said first and second securing sections respectively.

42. A securing mechanism according to claim 9, further comprising at least one reinforcing rib between one of said first and third securing sections and said second and fourth securing sections.

43. A securing mechanism according to claim 9, wherein at least one of said first and third securing sections, or at least one of said second and fourth securing sections are complete circles or ellipses; joined by at least one reinforcing rib.

44. A securing mechanism according to claim 1, wherein said central fixing area is a rectangular or circular plate.

45. A securing mechanism according to claim 1, said central fixing area can be releasably secured to said stand for supporting or receiving an upright to said central securing region.

46. A securing mechanism according to claim 1, further comprising a detachable elevation component, on the top surface of said central fixing, to raise the height of the stand above the platform.

47. A securing mechanism according to claim 1, further comprising a second extension support, extending substantially horizontally from one of said first securing section or said central fixing area, to be positioned to be adjacent and parallel to said top surface of a floatable structure.

48. A securing mechanism according to claim 16 wherein the second extension support has the same configuration as the first extension support.

49. A securing mechanism according to claim 1, that is formed of metal.

50. A securing mechanism according to claim 1, that is formed of plastic or carbon.

51. An assembly for securing an upright to a floating or inflatable platform comprising a securing mechanism according to any preceding claim and an upright stand to be secured to said securing mechanism.
